(19) United States
(12) Patent Application Publication
(10) Pub. No.: US 2002/0023031 A1
(43) Pub. Date: Feb. 21, 2002

(54) Providing method of processing relevant information and its system

(76) Inventors: Akira Mori, Chigasaki-city (JP); Teiichirou Chiba, Hiratsuka-city (JP)

Correspondence Address: VARNDELL & VARNDELL, PLLC, 106-A South Columbus Street, Alexandria, VA, 22314, US

(21) Appl. No.: 09/880,017

(22) Filed: Jun. 14, 2001

(30) Foreign Application Priority Data
Jun. 20, 2000 (JP) 2000-184466

(51) Int. Cl. G06F 17/60

(52) U.S. Cl. 705/35

(57) ABSTRACT

A host device evaluates the writing quality of an ID for management based on digital information showing the writing quality of the ID for management received from an information terminal through a communication network. The host device also executes a correction of information relative to various conditions for marking the ID for management to a semiconductor wafer in accordance with results of the evaluation. Information relative to the evaluation results is transmitted to a terminal for accounting/money collection through the communication network. The terminal for accounting/money collection receives information of the number of writing times transmitted from the terminal, and the information relative to the evaluation results and transmitted from the host device, and then calculates an effective writing time number of the ID for management. The terminal for accounting/money collection executes predetermined accounting processing and money collection processing based on these calculated results.

### BACKGROUND OF THE INVENTION

1. Field of the Invention

The present invention relates to a providing method of processing relevant information and its system.

2. Description of the Related Art

As is well known, it is necessary to use a processor itself in mechanical processing of various kinds of products. Further, a technique relative to a using way (using method) of this processor, i.e., various kinds of know-how, a setting technique of a using condition, etc. are also required.

These know-how and setting technique of the using condition are obtained by accumulating the actual experiences, etc. of processing of the products using the processor, and are accumulation of the results of various trials and errors. A technical field belonging to these know-how and setting technique is a technical field of so-called software, and is therefore clearly different from the technical field of hardware to which the processor belongs. Accordingly, the know-how itself ought to independently have economical values.

However, in the conventional commercial custom, the software (namely, the know-how, the setting technique of the using condition, etc.) is generally sold in a so-called tie-in state combined with a processor for fulfilling an original function for the first time by mounting this software. Therefore, no economical rationality ought to be damaged at all even when buying and selling prices are originally requested on a user side from a maker side of the processor by adding a transaction price of the software to the transaction price of a main body of the processor. However, in reality, the buying and selling prices must be requested in a state in which the transaction price of the software is included in the transaction price of the processor.

In such a real situation, even when the software is developed by throwing-in considerable capital and time and is very excellent in comparison with the conventional case, it is difficult to collect the capital required for this development. Therefore, the evaluation of a developer (a personal engineer, an enterprise, etc.) of the software is lower than the evaluation of a developer (a personal engineer, an enterprise, etc.) of the processor, and there is almost no economical collateral (remuneration). Accordingly, the developer lays emphasis on an improvement of the processor as the hardware instead of the software.

As a result, even when performance of the existing processor can be greatly improved only by improving the software, the improvement of the processor performance is intended by improving the hardware. Therefore, every time a new function (a simple function) is developed, a processor adding this function thereto is developed and sold in succession. Accordingly, the existing device able to be still sufficiently used is used only once and then thrown away to accelerate novel rebuying so that waste of resources is accelerated. Therefore, there is a fear that environmental destruction is caused.

### SUMMARY OF THE INVENTION

Accordingly, the present invention is aimed to perform accounting and money collection of software mounted to a processor in an amount of money corresponding to a transaction price of the software independently of the collection of buying and selling prices of a transaction price of the processor.

A providing system of processing relevant information in accordance with a first aspect of the invention comprises a processor for receiving the processing relevant information including a processing method through a communication network, and performing predetermined processing with respect to a processing object on the basis of this information; a processing relevant information generator for generating the processing relevant information and supplying this information to the processor through the communication network; and a processing state information generator for generating information showing a detected processing state of the processing object, and supplying this information to the processing relevant information generator through the communication network; wherein the processing relevant information generator corrects the processing relevant information on the basis of the processing state information supplied from the processing state information generator.

In accordance with the above construction, the processing relevant information generator corrects the processing relevant information on the basis of the processing state information supplied from the processing state information generator through the communication network. Accordingly, the processing relevant information supplied from the processing relevant information generator to the processor is corrected in accordance with the actual processing state in the processing object. As a result, the processing relevant information able to perform processing of higher quality with respect to the processing object can be automatically supplied from the processing relevant information generator to the processor through the communication network. Further, since the processing relevant information is automatically supplied from the processing relevant information generator to the processor through the communication network, accounting processing and money collection processing can be automatically performed from a supply source of the processing relevant information to a user side every time effective processing relevant information is supplied to the processor. Therefore, different from the conventional case, a developer of the processing relevant information can receive an economical collateral (remuneration). Accordingly, it is reduced to lay emphasis on an improvement of the processor as hardware in comparison with software. As a result, when performance of the existing processor can be greatly improved only by improving the processing relevant information, it is reduced to daringly start an improvement of the hardware. Accordingly, it is reduced that the existing device able to be still sufficiently used is used only once and then thrown away. Thus, resources can be effectively used practically, and environmental destruction can be prevented.

A providing method of processing relevant information in accordance with a second aspect of the invention comprises the steps of a process for receiving the processing relevant information including a processing method through a communication network, and performing predetermined processing with respect to a processing object on the basis of this information by a processor; a process for generating the processing relevant information and supplying this information to the processor through the communication network by a processing relevant information generator; and a process for generating information showing a detected processing state of the processing object, and supplying this information to the processing relevant information generator through the communication network by a processing state information generator; wherein the providing method further comprises a process for correcting the processing relevant information on the basis of the processing state information by the processing relevant information generator when the processing state information is supplied from the processing state information generator.

A program recording medium in accordance with a third aspect of the invention has a computer program for fulfilling the function of a computer as each of the following devices in a providing system of processing relevant information comprising a processor for receiving the processing relevant information including a processing method through a communication network, and performing predetermined processing with respect to a processing object on the basis of this information; a processing relevant information generator for generating the processing relevant information and supplying this information to the processor through the communication network; and a processing state information generator for generating information showing a detected processing state of the processing object, and supplying this information to the processing relevant information generator through the communication network; wherein the processing relevant information generator corrects the processing relevant information on the basis of the processing state information supplied from the processing state information generator.

### BRIEF DESCRIPTION OF THE DRAWINGS

FIG. 1 is a block diagram showing one embodiment of a marking system of a semiconductor wafer as a providing system of processing relevant information in accordance with one embodiment mode of the present invention.

### DESCRIPTION OF THE PREFERRED EMBODIMENTS

The embodiment modes of the present invention will next be explained in detail by the drawings.

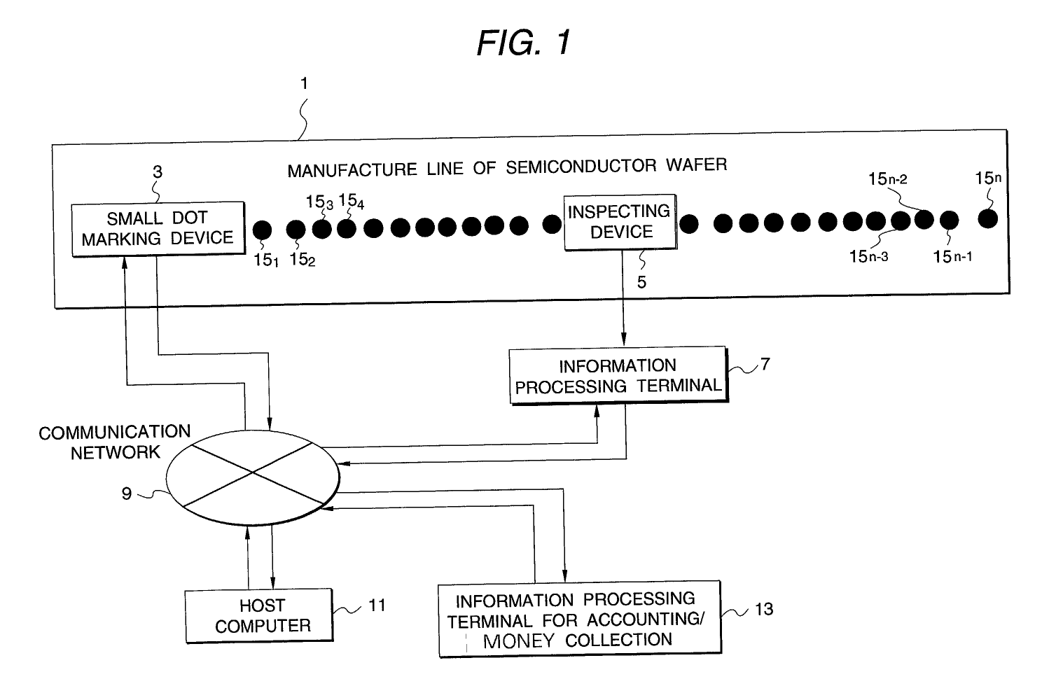

FIG. 1 is a block diagram showing one embodiment of a marking system of a semiconductor wafer as a providing system of processing relevant information in accordance with one embodiment mode of the invention.

As shown in FIG. 1, this system is constructed by a manufacturing line 1 of the semiconductor wafer (manufacturing line), a small dot marking device (marking device) 3, an inspecting device 5, an information processing terminal 7, a communication network 9, a host computer (host device) 11 and an information processing terminal 13 for accounting/money collection.

The marking device 3 is arranged to write an ID (ID for management) required to manage each semiconductor wafer (15₁ to 15ₙ) in a suitable portion of each semiconductor wafer conveyed in a state in which the semiconductor wafer is stored to a wafer cassette on the manufacturing line 1. The marking device 3 is arranged on an upstream side of the semiconductor wafer (15₁ to 15ₙ) in its moving direction on the manufacturing line 1. The ID for management is a mark used in process management and product management of the semiconductor wafer (15₁ to 15ₙ) Similar to a mark such as a bar code, characters, and a number (e.g., showing a speck, a product number) for finding a clue to a processing condition, a processing record, or electric characteristics till the present time of each semiconductor wafer (15₁ to 15ₙ), the ID for management is formed in a suitable position on a surface of each semiconductor wafer (15₁ to 15ₙ).

For example, the marking device 3 is constructed by using a laser marker in which marking is performed on the surface of the semiconductor wafer (15₁ to 15ₙ) by a laser beam with an SHG type YAG laser as a base. The laser marker has a laser oscillator for emitting the laser beam having an energy density distribution of a Gaussian shape, and a beam homogenizer for forming the laser beam in an energy density distribution shape of a top hat type approximately having a uniform peak value. The laser marker also has a liquid crystal mask and a beam profile converter. In the liquid crystal mask, plural liquid crystals are arranged in a matrix shape, and various kinds of marking patterns able to transmit the laser beam are freely set. In the beam profile converter, plural liquid crystals are arranged in a matrix shape, and the laser beam incident through the liquid crystal mark is converted to an energy density distribution shape required to form a small dot shape. In addition to each of the above portions, the laser marker also has a reduction lens unit for performing dot marking required in a predetermined position on the surface of the semiconductor wafer (15₁ to 15ₙ) by irradiating the laser beam incident through the beam profile converter in this position.

The marking device 3 is operated/stopped under control of an unillustrated information processing terminal (e.g., a personal computer terminal) mounted to this marking device 3. This information processing terminal has a function for transmitting and receiving information between this information processing terminal and another information processor (the host device 11 described later) through the communication network 9 such as the Internet. The information processing terminal obtains a program (application program) for the operation of the marking device 3 through the communication network 9 (i.e., on on-line) or off-line from the host device 11, and also obtains information relative to various conditions for marking. The operation of each portion of the marking device 3 is controlled on the basis of the program for the operation and the various conditions.

The inspecting device 5 is arranged on a downstream side of the semiconductor wafer (15₁ to 15ₙ) in its moving direction on the manufacturing line 1 seen from the marking device 3. The inspecting device 5 has a function for reading the ID for management written to each semiconductor wafer (15₁ to 15ₙ) by the marking device 3, and a function for counting the number of writing times of the ID for management written by the marking device 3.

The inspecting device 5 outputs information showing which state the ID for management in each semiconductor wafer (15₁ to 15ₙ) is written in when the ID for management is read. In other words, the inspecting device 5 outputs information (analog information) showing writing quality of the ID for management to the information processing terminal 7. The inspecting device 5 also outputs information of the number of writing times of the counted ID for management to the information processing terminal 7.

For example, the information processing terminal 7 is constructed by using a personal computer terminal having a function for transmitting and receiving information between this information processing terminal 7 and the host device 11 and the information processing terminal 13 for accounting/money collection through the communication network 9. The information processing terminal 7 generates digital information showing the writing quality on the basis of the analog information from the inspecting device 5 to easily evaluate the writing quality of the ID for management, and outputs this digital information to the host device 11 through the communication network 9. The information processing terminal 7 also outputs the information of the number of writing times to the information processing terminal 13 for accounting/money collection through the communication network 9.

An application server is constructed in the host device 11. The application server accumulates the program for operating the marking device 3, i.e., the application program, and transmits the corresponding program for the operation to the unillustrated information processing terminal through the communication network 9 in accordance with a request from the information processing terminal.

The host device 11 also generates information relative to various conditions for marking the ID for management in the semiconductor wafer (15₁ to 15ₙ) in accordance with instructions from an operator, and transmits information relative to these various conditions to the information processing terminal through the communication network 9.

For example, the information relative to the various conditions is constructed by characters of the marking device 3 such as a kind of a mark (a bar code, an alphabetical letter, a Greek letter, a number) constituting the ID for management, a kind, a shape, a size and characters of the marked semiconductor wafer, a driving method, a driving time and the magnitude of power of a laser beam of the laser oscillator. In addition to this, the information relative to the various conditions further includes a setting method of the marking device 3 and know-how of the operation.

For example, a dot projected upward to represent the ID for management can be formed rapidly and accurately in a predetermined position of the semiconductor wafer (15₁ to 15ₙ) by suitably adjusting a condition relative to the irradiation of the laser beam such as the driving method, the driving time of the laser oscillator. Further, a hole for represent the ID for management can be formed in the predetermined position of the semiconductor wafer (15₁ to 15ₙ) by suitably adjusting the magnitude of power of the laser beam. It is known that reading accuracy of the inspecting device 5 in the ID for management represented by the dot projected upward is very higher than that in the ID for management represented by the hole, even when the same ID for management is used.

The host device 11 evaluates the writing quality of the ID for management on the basis of the digital information showing the writing quality and received from the information processing terminal 7 through the communication network 9. The host device 11 also executes a correction of the various conditions in accordance with results of this evaluation. The host device 11 then transmits information relative to the corrected various conditions to the unillustrated information processing terminal of the marking device 3 through the communication network 9. In other words, the information relative to the various conditions is suitably corrected in the host device 11 on the basis of the digital information fed back to the host device 11 from the inspecting device 5 through the information processing terminal 7 and the communication network 9. Thereafter, the corrected information is transmitted to the unillustrated information processing terminal of the marking device 3. Information relative to the above evaluation results is transmitted from the host device 11 to the information processing terminal 13 for accounting/money collection through the communication network 9.

The information processing terminal 13 for accounting/money collection receives the information of the number of writing times transmitted from the information processing terminal 7 through the communication network 9, and the information relative to the evaluation results transmitted from the host device 11 through the communication network 9. The information processing terminal 13 for accounting/money collection then calculates an effective writing time number of the ID for management. The information processing terminal 13 for accounting/money collection then executes predetermined accounting processing and money collection processing on the basis of results of this calculation.

In accordance with the above construction, the information relative to the various conditions and transmitted by the host device 11 to the unillustrated information processing terminal of the marking device 3 through the communication network 9 is suitably corrected on the basis of the digital information fed back from the inspecting device 5 to the host device 11 through the information processing terminal 7 and the communication network 9. As a result, the information relative to the various conditions able to mark the ID for management to the semiconductor wafer (15₁ to 15ₙ) in higher quality can be automatically transmitted from the host device 11 to the unillustrated information processing terminal of the marking device 3 through the communication network 9.

As mentioned above, the information relative to the various conditions is automatically transmitted from the host device 11 to the unillustrated information processing terminal of the marking device 3 through the communication network 9. Accordingly, accounting processing and money collection processing can be automatically performed from a maker side as a supply source of the information relative to the various conditions to a user side every time effective information relative to the various conditions can be transmitted to the unillustrated information processing terminal of the marking device 3. Therefore, different from the conventional case, the maker side as a supply source of the information relative to the various conditions can receive an economical collateral (remuneration). Accordingly, it is reduced to lay emphasis on an improvement of the processor as hardware in comparison with software. As a result, when performance of the existing marking device 3 can be greatly improved only by improving the information relative to the various conditions, the case of daringly starting an improvement of the hardware is reduced. Accordingly, it is reduced that the existing device (marking device 3) able to be still sufficiently used is used only once and then thrown away. Therefore, resources can be effectively used practically, and environmental destruction can be prevented.

The above explained contents relate to one embodiment mode of the invention, and it means that the invention is not limited to only the above contents.

As explained above, in accordance with the invention, accounting and money collection of software mounted to the processor can be performed in an amount of money corresponding to a transaction price of the software independently of the collection of buying and selling prices of a transaction price of the processor.

What is claimed is:

1. A providing system of processing relevant information comprising:
a processor for receiving the processing relevant information including a processing method through a communication network, and performing predetermined processing with respect to a processing object on the basis of this information;
a processing relevant information generator for generating said processing relevant information and supplying this information to said processor through the communication network; and
a processing state information generator for generating information showing a detected processing state of said processing object, and supplying this information to said processing relevant information generator through the communication network;
wherein said processing relevant information generator corrects said processing relevant information on the basis of said processing state information supplied from said processing state information generator.

2. A providing method of processing relevant information comprising the steps of:
a process for receiving the processing relevant information including a processing method through a communication network, and performing predetermined processing with respect to a processing object on the basis of this information by a processor;
a process for generating said processing relevant information and supplying this information to said processor through the communication network by a processing relevant information generator; and
a process for generating information showing a detected processing state of said processing object, and supplying this information to said processing relevant information generator through the communication network by a processing state information generator;
wherein said providing method further comprises a process for correcting said processing relevant information on the basis of said processing state information by said processing relevant information generator when said processing state information is supplied from said processing state information generator.

3. A program recording medium having a computer program for fulfilling the function of a computer as each of the following devices in a providing system of processing relevant information comprising:
a processor for receiving the processing relevant information including a processing method through a communication network, and performing predetermined processing with respect to a processing object on the basis of this information;
a processing relevant information generator for generating said processing relevant information and supplying this information to said processor through the communication network; and
a processing state information generator for generating information showing a detected processing state of said processing object, and supplying this information to said processing relevant information generator through the communication network;
wherein said processing relevant information generator corrects said processing relevant information on the basis of said processing state information supplied from said processing state information generator.
